(19) United States
(12) Patent Application Publication
(10) Pub. No.: US 2021/0208918 A1
(43) Pub. Date: Jul. 8, 2021

(54) INTELLIGENT SESSION TIMEOUTS FOR VIRTUAL WORKSPACE

(71) Applicant: Citrix Systems, Inc., Fort Lauderdale, FL (US)

(72) Inventors: Leo C. Singleton, IV, Fort Lauderdale, FL (US); Nitin Devendra Mehta, Pompano Beach, FL (US); Jose Augustin, Boca Raton, FL (US); Martin Zugec, Boca Raton, FL (US); Adith Jayakar Hegde, Parkland, FL (US)

(21) Appl. No.: 16/736,204

(22) Filed: Jan. 7, 2020

(51) Int. Cl. G06F 9/455; G06F 9/451

(52) U.S. Cl. CPC G06F 9/45558; G06F 2009/45595; G06F 9/452

(57) ABSTRACT

A system and method for determining session timeout periods for a virtual workspace. A method is disclosed that includes detecting an inactivity state of a user engaged with a session running on a server; implementing a first timeout period in response to the inactivity state occurring during a defined time period; and implementing a second timeout period in response to the inactivity state occurring outside the defined time period, wherein the second timeout period is less than the first timeout period. The timeout period may further be determined by determining a session cost, determining a reconnect probability and/or determining a security risk.

### BACKGROUND OF THE DISCLOSURE

In a typical virtual workspace, users log into the workspace to access virtual applications and services. When a login occurs, a session is initiated on a virtual machine running on a server, e.g., in a cloud system or enterprise network. Each such server is capable of running multiple virtual sessions for different users, and the server may be powered down when no sessions are running to conserve energy and reduce operational costs. Sessions are terminated when a user logs off from the workspace. In addition to logging off, users may be disconnected from the workspace, e.g., after a brief period of inactivity, and at some predefined time thereafter the session will automatically timeout (i.e., terminate) to ensure the servers are not kept powered when there is no session activity. The timeout period affords the user an opportunity to reengage with the session so that the session is not inadvertently terminated.

### BRIEF DESCRIPTION OF THE DISCLOSURE

Aspects of this disclosure provide a system and method for calculating session timeouts and terminating sessions when an inactivity state for a virtual session is detected in a virtual workspace using an intelligent process to more efficiently manage server usage.

A first aspect of the disclosure provides a method of terminating a virtual session running on a server. The method includes detecting an inactivity state of the virtual session and determining whether the inactivity state is detected during a defined time period or outside the defined time period. A timeout period is implemented at least based on the determination whether the inactivity state is detected during the defined time period or detected outside the defined time period and the virtual session is terminated after the timeout period expires.

A second aspect of the disclosure provides a computing system that includes a memory and a processor coupled to the memory configured to terminate a virtual session running on a server according to a method. The method includes detecting an inactivity state of the virtual session and determining whether the inactivity state is detected during a defined time period or outside the defined time period. A timeout period is implemented at least based on the determination whether the inactivity state is detected during the defined time period or detected outside the defined time period; and the virtual session is terminated after the timeout period expires.

A third aspect of the disclosure provides a computing system that includes a memory and a processor coupled to the memory configured to terminate a virtual session running on a server according to a method. The method includes detecting an inactivity state of the virtual session running on a server and determining a session cost for the virtual session. A timeout period is implemented at least based on whether the session cost is greater than a threshold and the virtual session is terminated after the timeout period expires.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts an illustrative workspace environment in accordance with an illustrative embodiment.

FIG. 2 depicts a flow diagram of a process for determining timeout periods, in accordance with an illustrative embodiment.

FIG. 3 depicts a computing system having a session manager for determining timeout periods, in accordance with an illustrative embodiment.

FIG. 4 depicts a network infrastructure, in accordance with an illustrative embodiment.

FIG. 5 depicts a cloud computing diagram, in accordance with an illustrative embodiment.

The drawings are intended to depict only typical aspects of the disclosure, and therefore should not be considered as limiting the scope of the disclosure.

### DETAILED DESCRIPTION OF THE DISCLOSURE

Embodiments of the disclosure provide technical solutions for managing server sessions utilized by a virtual workspace, and more particularly, for conserving power and reducing operational costs. In one embodiment, an intelligent process is utilized to determine a session timeout period in response to a detected inactivity state associated with a session. Using this approach, the session timeout period will vary depending on one or more factors that are evaluated at the time the inactivity state is detected such that different sessions will be afforded different timeout periods. In prior approaches, session timeout periods were configured as fixed values by an administrator, which can lead to computational waste when machines (i.e., servers) are kept powered on and reserved for hours with no actual user activity. The present approach provides a technical solution to this problem by determining a tailored timeout period based on one or more factors when an inactivity state is detected. This more robustly ensures that servers are not left consuming power when the likelihood that a user will reengage to a session is low.

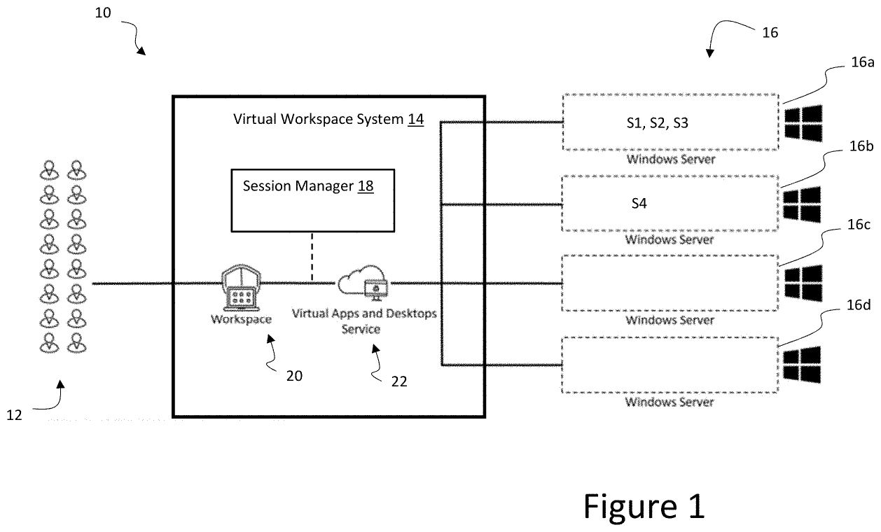

FIG. 1 depicts an illustrative workspace environment 10 that generally includes a set of users 12 that engage with a virtual workspace system 14 via endpoint computing devices, e.g., desktops, laptops, smart devices, etc. While users 12 are generally described as people, users 12 may also include non-human entities such as software agents, Internet of Things (IoT) devices, autonomous systems, etc. Users may access the virtual workspace system 14 through virtualization client applications installed on user endpoint computing devices that are configured to provide users with access to virtual resources, such as virtual applications, virtual desktops, and virtual servers that are hosted by computing devices physically distinct from the endpoint devices. The virtualization client applications may connect to a workspace application 20 (e.g., Citrix® Workspace or the Citrix® Receiver, both of which are commercially available from Citrix Systems of Fort Lauderdale, Fla. in the United States) which may deliver virtual resources such as virtual applications and virtual desktop services 22, which run on a set of servers 16. Servers 16 may for example be implemented in any manner, e.g., as a data center, a public or private cloud, a server farm, etc.

Users 12 access the virtual workspace system 14 generally by logging in from a client device, which causes a virtual session to be created on a server 16a, 16b, 16c, 16d by a session manager 18. In the example shown, sessions S1, S2, and S3 are running on server 16a, session S4 is running on server 16b, and no sessions are running on servers 16c and 16d. Accordingly, in the depicted example, servers 16c and 16b can be powered down (e.g., into a low power or sleep mode) to conserve power and reduce operational costs until new sessions are implemented thereon. When a user 12 logs out, the associated session is terminated and the server can be powered down if there are no other sessions are running on the server. For example, if session S4 is terminated, server 16b can be powered down since there are no other sessions running.

As noted, sessions can also be timed out and terminated after a period of time if an inactivity state is detected. An inactivity state may be triggered by any indication that the user does not intend on reengaging with the session, e.g., a session disconnect, a period of user inactivity, etc. The inactivity state can thus occur when the user is automatically timed off a client device for inactivity, after a period of inactivity detected by the workspace, virtual service, server or virtualization client application, in response to a client device shutdown without a log off, in response to a network issue, etc. As noted, an inactivity state such as a session disconnect however does not terminate the session. Instead, the inactivity state triggers a timeout period during which the user can reengage (i.e., reconnect) with the session, e.g., by re-logging in, moving the mouse, etc. As noted, in past implementations, sessions were terminated after a fixed timeout period, e.g., one hour, regardless of the circumstances.

In the present approach, session manager 18 determines a tailored timeout period using an intelligent process at the time an inactivity state is detected. In one illustrative embodiment, the session manager 18 evaluates various factors, including a defined time period (e.g., the operating hours of a business), the relative cost of the session, the usage patterns of the particular user, security risks of the user, etc.

In one illustrative example, different timeout periods are utilized if the inactivity state is detected during normal business hours versus outside normal business hours. For example, if a business operates from Monday to Friday, 9 am to 5 pm, then a generally relaxed timeout period (referred to herein as “baseline timeout period”) may be used during normal business hours since there is a relatively higher likelihood that the user will reengage than during non-business hours. Outside of normal business hours a more aggressive (i.e., shortened) timeout period can be used. Note that the baseline timeout period can include any defined time period that delineates when users are generally more likely to remain active than not. For instance, the defined time period may include hours on weekends and evenings when employees tend to be logged in. Further, other times may be excluded from the defined time period, e.g., days when the office is scheduled to be closed, meeting times, etc. Still further the defined time period could be broken into subranges (e.g., morning versus afternoon) that are assigned different baseline timeout periods.

In addition to determining timeout periods based on business hours (or alternatively thereto) timeout periods can be implemented based on a relative cost of the session. For example, if there is only one session running on a server, such as server 16b, then a more aggressive timeout period (e.g., 15 minutes) could be utilized in order to free up the server quicker since the session cost is relatively high compared to a server that has many sessions running. In one example, the session cost may be calculated as:

$$\frac{cost of server instance}{total number of sessions running on the server} .$$

For example, if a server costs $10 per hour and currently hosts 25 user sessions, the cost index is 40 cents. If only one session is running, then the cost is $10.00 per hour, if two sessions are running then the cost is $5.00 per hour, if three sessions are running then the cost is $0.33 per hour, etc. The cost may then be compared to a cost threshold (e.g., $0.40) to determine if the cost is above the cost threshold and if so, the more aggressive timeout period is utilized. The cost threshold may be selected in any manner, e.g., by an administrator based on system configurations.

In a further embodiment, the session manager 18 can consider historical usage patterns of the particular user 12 to determine the timeout period. For instance, during non-business hours, the session manager 18 can evaluate the probability that the user will reconnect based on past behaviors. For example, historical usage patterns may be analyzed to determine the average amount of time T_{A} a given user remains logged in during non-business hours (e.g., 50 minutes). Based on the amount of time T_{L} the user was logged in prior to the inactivity state (e.g., 40 minutes), a probability P of a reconnect can be calculated. For example the probability may be calculated as: P=(T_{A}−T_{L})/T_{A}, which in the current example would result in a probability of P=(50−40)/50=0.20. The probability P is then be compare to a probability threshold (e.g., 0.50). If the calculated probability P is greater than the probability threshold, then a relatively longer timeout period could be used (e.g., the baseline timeout period used for business hours or some other relatively long period such as 45 minutes). Otherwise, if the probability P is lower than the probability threshold, then a relatively shorter timeout period can be used (e.g., the shortened timeout period used for non-business hours or some other period such as 10 minutes). The probability threshold may likewise be determined in any manner.

In addition to the above, security risk profile factors could also be utilized to determine timeout periods, including the privilege level of the user, location of the user, a user's role in the organization, etc. For example, if a user has access to or tends to work on projects of a heightened security risk, the timeout period can be further shortened. For instance, if a session disconnect occurred during normal business hours, the baseline timeout period might be defined as one hour. However, for users that access data that is subject to a higher security risk, their timeout period might be reduced by 50% of the normal user (i.e., 30 minutes for session disconnects occurring during business hours). The shortened period would reduce that risk of an attack by minimizing idle time. Furthermore, the timeout period might be further adjusted based on whether the user is in the office, at home, in a public space, etc., where different risk profiles exist.

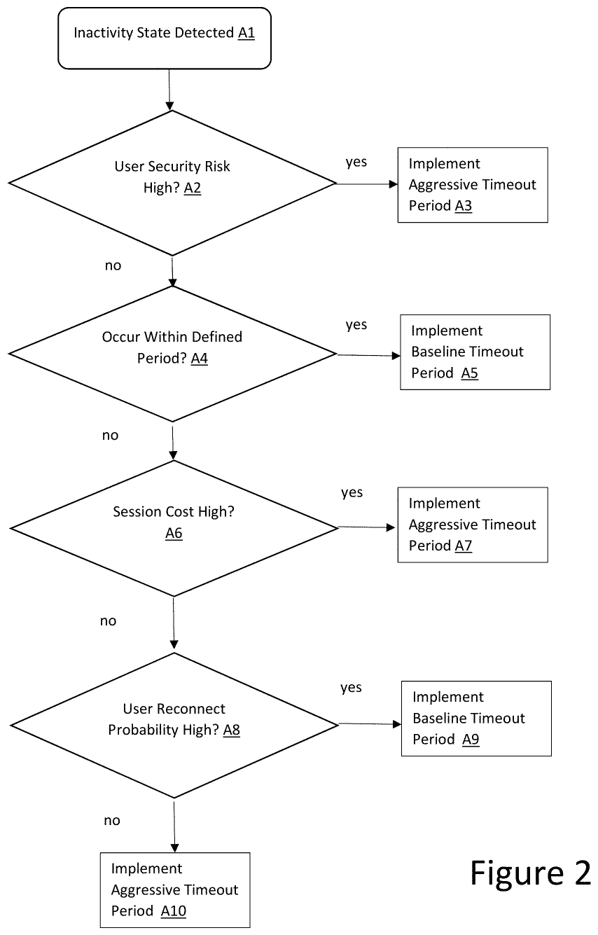

FIG. 2 depicts a flow diagram of an illustrative process for determining session timeouts. At A1, an inactivity state is detected for a session running on an associated server and then at A2 a determination is made whether the user security risk is high. As noted, security risk may be based on a security profile of the user that, e.g., considers the users privileges, role in the organization, location, etc. If yes at A2, then an aggressive timeout period is implemented (e.g., 15 minutes) at A3. If no at A2, then a determination is made whether the detection occurred during a defined time period (e.g., normal business hours) at A4. If yes at A4, then a baseline timeout period (e.g., one hour) is implemented at A5. If no at A4, then a determination is made at A6 whether the session cost is high. Session cost may be determined based on the number of sessions running on the associated server, which is then compared to a cost threshold, as described herein. If the session cost is deemed high at A6, then the aggressive timeout period is implemented (e.g., 15 minutes) at A7. If the session cost is not deemed high (i.e., no at A6), then a determination is made at A8 whether the reconnect probability of the particular user is high. Reconnect probability may be based on historical usage patterns of the user and compared to a probability threshold, as described herein. If the reconnect probability is high at A8, then the baseline timeout period (e.g., one hour) is implemented at A9. If the reconnect probability is not high at A8, then the aggressive timeout period (e.g., 15 minutes) is implemented at A10. Alternatively, rather than using just two timeout periods, e.g., the baseline and aggressive timeout periods, other (e.g., third and fourth) timeout periods could be utilized. For example, the results of the decision at A8 could utilize other time periods so long as a high reconnect probability results in a relatively longer timeout period than that used for a low reconnect probability. Furthermore, while the embodiment of FIG. 2 considers four factors (business hours, security risk, session costs, and reconnect probability), any one or combination of two or more of the factors (or additional factors) could be utilized to determine a timeout period, and need not occur in the order described.

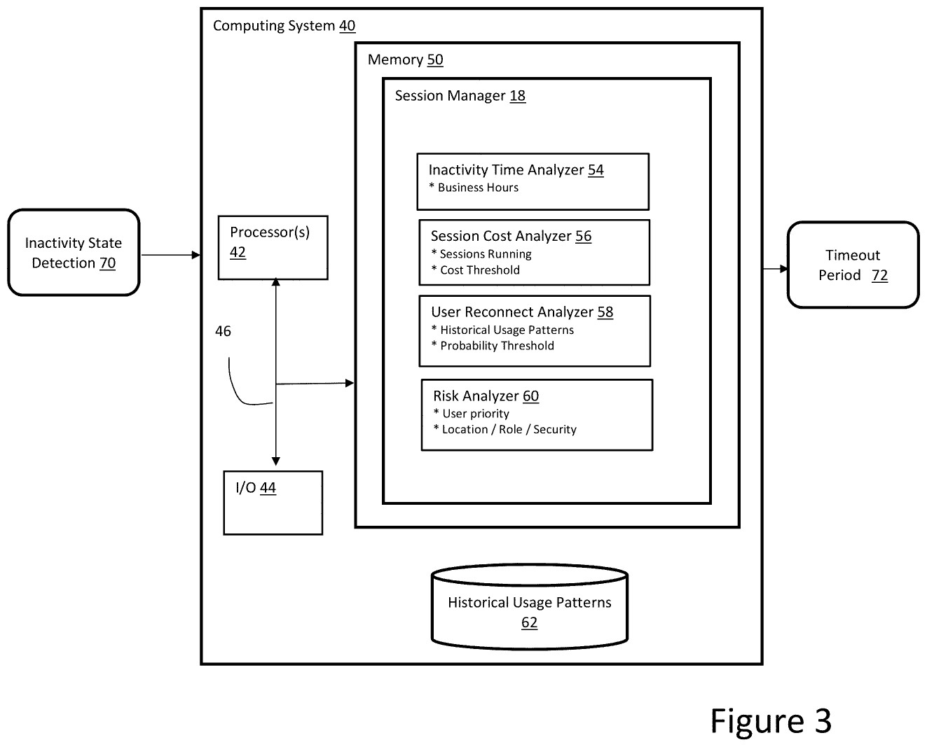

FIG. 3 depicts an illustrative computing system 40 having a session manager 18 that is configured to determine a timeout period 72 in response to an inputted inactivity state detection 70. As noted, an inactivity state may for example occur anytime a user is disconnected from a session or there is a period of inactivity detected by the client device or virtual workspace system 14 (FIG. 1). In this illustrative embodiment, session manager 18 determines the timeout period 72 using one or more subsystems 54, 56, 58, 60 that analyze different factors. The illustrative subsystems include, e.g., an inactivity time analyzer 54 that determines whether the inactivity state occurred during a defined time period, e.g., business hours; a session cost analyzer 56 that determines and analyzes a cost associated with the session, e.g., based on the number of other sessions running on the same server; a user reconnect analyzer 58 that evaluates a probability that the user will reconnect, e.g., based on historical usage patterns 62; and a risk analyzer 60 that for example evaluates risk profiles of the session, e.g., based on a privilege setting, location, role of the user, etc.

Historical usage patterns 62 may include any information relating to when, where, and how users log in and out, how often each user is disconnected, how long it takes the user to reconnect after an inactivity state is detected, etc. The patterns may be stored in a database, table, or other data structure.

The resulting timeout period 72 is determined as a function of some or all of the various subsystems (54, 56, 58, 60), e.g., as described in the flow diagram of FIG. 2. Any process or set of rules that uses one or more of the subsystems may be deployed. For instance, the following rules may be used to calculate the timeout period 72:
1. If the inactivity state occurred during the defined time range, then use a baseline timeout period, otherwise use an aggressive timeout period;
2. If the session cost is high, then decrease the timeout period by a first amount;
3. If the user reconnect probability is high, then increase the timeout period by a second amount; and
4. If the risk profile is high, then decrease the timeout period by a third amount.

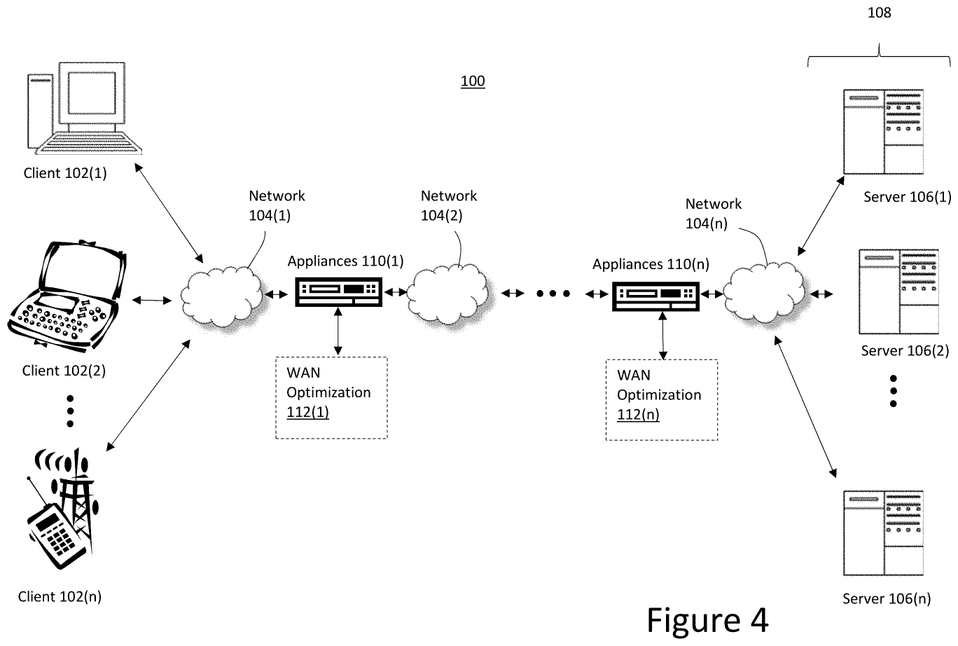

Referring to FIG. 4, an illustrative network environment 100 is depicted. Network environment 100 may include one or more clients 102(1)-102(n) (also generally referred to as local machine(s) 102, “client devices” or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 110(1)-110n (generally referred to as appliance(s) 110 or gateway(s) 110).

Although the embodiment shown in FIG. 4 shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 4, one or more appliances 110 may be located at various points or in various communication paths of network environment 100. For example, appliance 110(1) may be deployed between two networks 104(1) and 104(2), and appliances 110 may communicate with one another to work in conjunction to, for example, accelerate network traffic between clients 102 and servers 106. In other embodiments, the appliance 110 may be located on a network 104. For example, appliance 110 may be implemented as part of one of clients 102 and/or servers 106. In an embodiment, appliance 110 may be implemented as a network device such as Citrix networking (formerly NetScaler®) products sold by Citrix Systems, Inc. of Fort Lauderdale, Fla.

As shown in FIG. 4, one or more servers 106 may operate as a server farm 108. Servers 106 of server farm 108 may be logically grouped, and may either be geographically co-located (e.g., on premises) or geographically dispersed (e.g., cloud based) from clients 102 and/or other servers 106. In an embodiment, server farm 108 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 4, in some embodiments, appliances 110 may include, be replaced by, or be in communication with, one or more additional appliances, such as WAN optimization appliances 112(1)-112(n), referred to generally as WAN optimization appliance(s) 112. For example, WAN optimization appliance 112 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 112 may be a performance enhancing proxy or a WAN optimization controller. In one embodiment, appliance 112 may be implemented as Citrix SD-WAN products sold by Citrix Systems, Inc. of Fort Lauderdale, Fla.

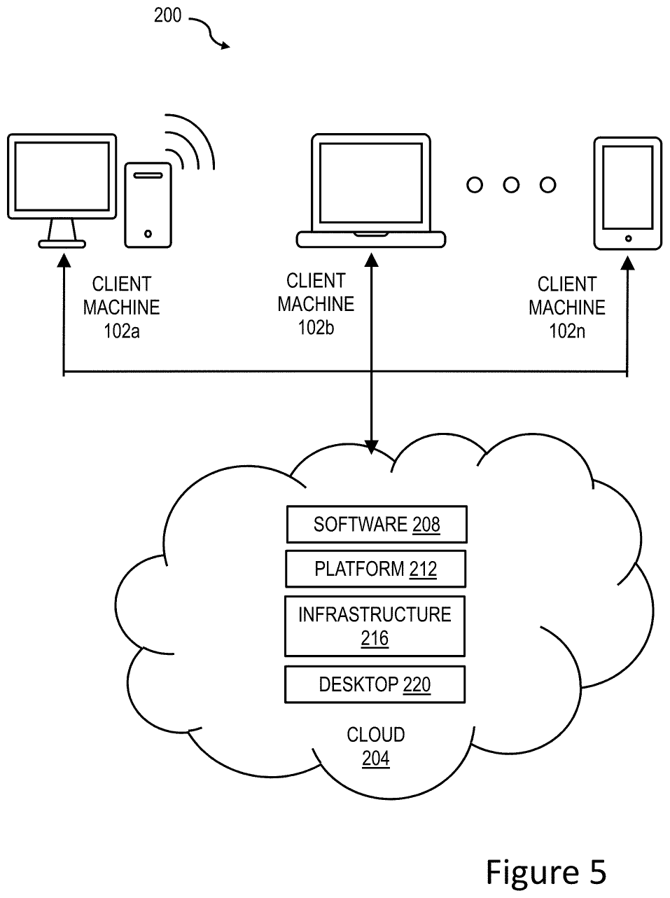

Referring to FIG. 5, a cloud computing environment 200 is depicted, which may also be referred to as a cloud environment, cloud computing or cloud network. The cloud computing environment 200 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 200, one or more clients 102a-102n (such as those described above) are in communication with a cloud network 204. The cloud network 304 may include back-end platforms, e.g., servers, storage, server farms or data centers. The users or clients 102a-102n can correspond to a single organization/tenant or multiple organizations/tenants. More particularly, in one example implementation the cloud computing environment 200 may provide a private cloud serving a single organization (e.g., enterprise cloud). In another example, the cloud computing environment 200 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 200 may provide a hybrid cloud that is a combination of a public cloud and a private cloud. Public clouds may include public servers that are maintained by third parties to the clients 102a-102n or the enterprise/tenant. The servers may be located off-site in remote geographical locations or otherwise.

The cloud computing environment 200 can provide resource pooling to serve multiple users via clients 102a-102n through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 200 can provide on-demand self-service to unilaterally provision computing capabilities (e.g., server time, network storage) across a network for multiple clients 102a-102n. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 200 can provide an elasticity to dynamically scale out or scale in response to different demands from one or more clients 102. In some embodiments, the cloud computing environment 200 can include or provide monitoring services to monitor, control and/or generate reports corresponding to the provided shared services and resources.

In some embodiments, the cloud computing environment 200 may provide cloud-based delivery of different types of cloud computing services, such as Software as a service (SaaS) 208, Platform as a Service (PaaS) 212, Infrastructure as a Service (IaaS) 216, and Desktop as a Service (DaaS) 220, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure such as AZURE CLOUD from Microsoft Corporation of Redmond, Washington (herein “Azure”), or AMAZON WEB SERVICES provided by Amazon.com, Inc., of Seattle, Wash. (herein “AWS”), for example. In the case of Citrix Cloud, Citrix Workspace app may be used as a single-entry point for bringing apps, files and desktops together (whether on-premises or in the cloud) to deliver a unified experience.

In described embodiments, clients 102, servers 106, and appliances 110 and 112 may be deployed as and/or executed on any type and form of computing device, such as any desktop computer, laptop computer, or mobile device capable of communication over at least one network and performing the operations described herein. For example, clients 102, servers 106 and/or appliances 110 and 112 may each correspond to one computer, a plurality of computers, or a network of distributed computers such as computing system 40 shown in FIG. 3. Computing system 40 (FIG. 3) may for example be implemented by a cloud computing environment that employs a network of remote, hosted servers to manage, store and/or process data, and may generally be referred to, or fall under the umbrella of, a “network service.”

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

Computing system 40 (FIG. 3) may comprise any type of computing device that for example includes at least one processor 42, memory, an input/output (I/O) 44, e.g., one or more I/O interfaces and/or devices, and a communications pathway or bus 46. In general, the processor(s) execute program code which is at least partially fixed in memory. While executing program code, the processor(s) can process data, which can result in reading and/or writing transformed data from/to memory and/or I/O for further processing. The pathway provides a communications link between each of the components in the computing device. I/O can comprise one or more human I/O devices, which enable a user to interact with the computing device and the computing device may also be implemented in a distributed manner such that different components reside in different physical locations.

Memory 50 may comprise volatile memory (e.g., RAM) and/or non-volatile memory e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof, etc. I/O 14 may include a user interface, a graphical user interface (GUI) (e.g., a touchscreen, a display, etc.) and one or more input/output (I/O) devices (e.g., a mouse, a keyboard, etc.). Computing system 40 typically may also include an operating system, additional applications, data, peripherals, etc. Computing system 40 is shown merely as an example, as clients, servers and/or appliances and may be implemented by any computing or processing environment and with any type of machine or set of machines that may have suitable hardware and/or software capable of operating as described herein.

Processor(s) 42 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

In described embodiments, a first computing device may execute an application on behalf of a user of a client computing device, may execute a virtual machine, which provides an execution session within which applications execute on behalf of a user or a client computing device, such as a hosted desktop session, may execute a terminal services session to provide a hosted desktop environment, or may provide access to a computing environment including one or more of: one or more applications, one or more desktop applications, and one or more desktop sessions in which one or more applications may execute.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method of terminating a virtual session running on a server, comprising:
detecting an inactivity state of the virtual session;
determining whether the inactivity state is detected during a defined time period or outside the defined time period;
implementing a timeout period at least based on the determination whether the inactivity state is detected during the defined time period or detected outside the defined time period; and
terminating the virtual session after the timeout period expires.

2. The method of claim 1, wherein a first timeout period is implemented in response to the inactivity state being detected during the defined time period, and a second timeout period is implemented in response to the inactivity state being detected outside the defined time period, the second timeout period being shorter than the first timeout period.

3. The method of claim 1, further comprising:
determining a session cost of the virtual session in response to detecting the inactivity state; and
wherein implementing the timeout period is at least based on the determination whether the inactivity state is during the defined time period or outside the defined time period, and the session cost of the virtual session.

4. The method of claim 3, wherein the session cost is based on a number of sessions running on the server.

5. The method of claim 1, further comprising:
determining a reconnect probability of the virtual session in response to detecting the inactivity state; and
wherein implementing the timeout period is at least based on the determination whether the inactivity state is during the defined time period or outside the defined time period, and the reconnect probability of the virtual session; and
wherein the reconnect probability is based on historical usage patterns of a user associated with the virtual session.

6. The method of claim 1, further comprising:
determining a security risk of the virtual session in response to detecting the inactivity state; and
wherein implementing the timeout period is at least based on the determination whether the inactivity state is during the defined time period or outside the defined time period, and the security risk of the virtual session.

7. The method of claim 1, wherein the defined time period includes a set of business hours.

8. The method of claim 1, wherein the inactivity state is triggered by one of: a session disconnect or a period of user inactivity.

9. A computing system, comprising:
a memory; and
a processor coupled to the memory and configured to terminate a virtual session running on server, according to a method comprising:
detecting an inactivity state of the virtual session;
determining whether the inactivity state is detected during a defined time period or outside the defined time period;
implementing a timeout period at least based on the determination whether the inactivity state is detected during the defined time period or detected outside the defined time period; and
terminating the virtual session after the timeout period expires.

10. The computing system of claim 9, wherein a first timeout period is implemented in response to the inactivity state being detected during the defined time period, and a second timeout period is implemented in response to the inactivity state being detected outside the defined time period, the second timeout period being shorter than the first timeout period.

11. The computing system of claim 9, the method further comprising:
determining a session cost of the virtual session in response to detecting the inactivity state; and
wherein implementing the timeout period is at least based on the determination whether the inactivity state is during the defined time period or outside the defined time period, and the session cost of the virtual session.

12. The computing system of claim 11, wherein the session cost is based on a number of virtual sessions running on the server.

13. The computing system of claim 9, the method further comprising:
determining a reconnect probability of the virtual session in response to detecting the inactivity state; and
wherein implementing the timeout period is at least based on the determination whether the inactivity state is during the defined time period or outside the defined time period, and the reconnect probability of the virtual session; and
wherein the reconnect probability is based on historical usage patterns of a user associated with the virtual session.

14. The computing system of claim 9, the method further comprising:
determining a security risk of the virtual session in response to detecting the inactivity state; and
wherein implementing the timeout period is at least based on the determination whether the inactivity state is during the defined time period or outside the defined time period, and the security risk of the virtual session.

15. The computing system of claim 9, wherein the defined time period includes a set of business hours.

16. The computing system of claim 9, wherein the inactivity state is triggered by one of: a session disconnect or a period of user inactivity.

17. A computing system, comprising:
a memory; and
a processor coupled to the memory and configured to terminate a virtual session according to a method that includes:
detecting an inactivity state of the virtual session running on a server;
determining a session cost for the virtual session;
implementing a timeout period at least based on whether the session cost is greater than a threshold; and
terminating the virtual session after the timeout period expires.

18. The computing system of claim 17, wherein the session cost is based on a number of virtual sessions running on the server.

19. The computing system of claim 17, wherein a first timeout period is implemented in response to the session cost exceeding the threshold, and a second timeout period is implemented in response to the session cost not exceeding the threshold, the second timeout period being longer than the first timeout period.

20. The computing system of claim 17, wherein the inactivity state is triggered by one of: a session disconnect or a period of user inactivity.
